(19) United States
(12) Patent Application Publication
(10) Pub. No.: US 2006/0203928 A1
(43) Pub. Date: Sep. 14, 2006

(54) Apparatus for decoding quasi-orthogonal space-time block codes

(75) Inventors: Kyung-Whoon Cheun, Pohang-si (KR); Jeong-Chang Kim, Pohang-si (KR); Young-Ho Jung, Seoul (KR)

Correspondence Address: DILWORTH & BARRESE, LLP, 333 EARLE OVINGTON BLVD., UNIONDALE, NY, 11553, US

(73) Assignees: Samsung Electronics Co., Ltd., Suwon-si (KR); Seoul National University Industry Foundation, Seoul (KR)

(21) Appl. No.: 11/284,322

(22) Filed: Nov. 21, 2005

(30) Foreign Application Priority Data
Mar. 14, 2005 (KR) 21008-2005

(51) Int. Cl. H04L 1/02

(52) U.S. Cl. 375/267

(57) ABSTRACT

An efficient decoding scheme of a receiver in a wireless communication system including a transmitter for encoding data into quasi-orthogonal space-time block codes (STBCs) and transmitting the STBCs through a plurality of transmit antennas using fading channels, and a receiver for receiving data through a plurality of receive antennas. In the decoding scheme, channel matched filtering is performed on M N-dimensional equivalent reception vectors \vec{y}ₘ received through M receive antennas and N-dimensional channel matched filtered vectors \vec{y}_{m,mat} are outputted. P L-dimensional sub-channel matched filtered vectors \vec{y}_{m,mat}ⁱ are generated from each of the N-dimensional channel matched filtered vectors \vec{y}_{m,mat}. P L-dimensional sub-equivalent channel matched filtered vectors \vec{y}_{m,mat}ⁱ are generated using the sub-channel matched filtered vectors \vec{y}_{m,mat}ⁱ. Iterative interference cancellation and maximum likelihood (ML) decoding are performed on each of the L-dimensional sub-equivalent channel matched filtered vectors \vec{y}ₘₐₜⁱ, and P L-dimensional sub-input vectors \vec{x}ⁱ are demodulated.

### PRIORITY

This application claims priority under 35 U.S.C. §119 to an application entitled “Apparatus for Decoding Quasi-Orthogonal Space-Time Block Codes” filed in the Korean Intellectual Property Office on Mar. 14, 2005 and assigned Serial No. 2005-21008, the contents of which are incorporated herein by reference.

### BACKGROUND OF THE INVENTION

1. Field of the Invention

The present invention generally relates to a wireless communication system, and more particularly to an efficient decoding scheme of a receiver in a transmission system using multiple antennas and quasi-orthogonal space-time block coding.

2. Description of the Related Art

To improve performance of a mobile communication system in a fading channel environment, a large amount of research is being conducted on a transmit antenna diversity scheme for transmitting data using multiple antennas.

Because the transmit antenna diversity scheme can obtain a diversity gain using a plurality of transmit antennas, it is a scheme suitable for the next generation high-speed data communication system.

To obtain an optimum transmit antenna diversity gain, space-time block codes (STBCs) with orthogonal characteristics based on an orthogonal design theory have been proposed. These STBCs have a maximum diversity order, and have an advantage in that maximum likelihood (ML) decoding can be performed in a receiving stage through a simple linear process.

However, when full rate orthogonal STBCs without using any additional frequency band employ a quadrature amplitude modulation (QAM) scheme, the maximum number of transmit antennas is only two.

When the number of transmit antennas is greater than two and STBCs do not have a special structure such as orthogonality in the QAM scheme, ML decoding complexity exponentially increases to Q^{N}, where the modulation order is Q and the number of transmit antennas is N.

STBCs using quasi-orthogonal characteristics have been proposed which can obtain the maximum diversity gain without using any additional frequency band in the case where the QAM scheme is used even when the number of transmit antennas is greater than two.

Even though the ML decoding complexity of quasi-orthogonal STBCs exponentially increases to Q^{N/2}, where the modulation order is Q and the number of transmit antennas is N, it is still low as compared with the ML decoding complexity of STBCs that do not have quasi-orthogonal characteristics.

Because the ML decoding complexity even in case of quasi-orthogonal STBCs exponentially increases in proportion to the number of transmit antennas, the ML decoding complexity becomes very high when the number of transmit antennas is greater than four or when a high modulation order is used.

To reduce the decoding complexity of quasi-orthogonal STBCs, suboptimal decoding schemes have been proposed which use a decorrelator, a minimum mean square error (MMSE) filter, or a successive interference canceller. However, because these decoding schemes do not obtain a diversity gain through the ML decoding method for given quasi-orthogonal STBCs, they have severe performance loss as compared with the ML decoding.

### SUMMARY OF THE INVENTION

It is, therefore, an aspect of the present invention to provide a new suboptimal decoding apparatus that can fundamentally reduce the decoding complexity of quasi-orthogonal space-time block codes (STBCs).

It is another aspect of the present invention to provide a new suboptimal decoding apparatus that can fundamentally reduce the decoding complexity of quasi-orthogonal space-time block codes (STBCs) as compared with an ML decoding method, without a sudden performance loss by combining interference cancellation and maximum likelihood (ML) decoding in a suboptimal decoding method.

To achieve the above and other aspects of the present invention, a suboptimal decoding apparatus includes a plurality of channel matched filters for performing channel matched filtering on M N-dimensional equivalent reception vectors \vec{y}ₘ (m=1, . . . , M) received through M receive antennas under a fading channel environment and outputting N-dimensional channel matched filtered vectors \vec{y}_{m,mat} (m=1, . . . ,M); a plurality of grouping units for generating P L-dimensional sub-channel matched filtered vectors \vec{y}_{m,mat}ⁱ (i=1, . . . ,P, m=1, . . . ,M) from each of the N-dimensional channel matched filtered vectors \vec{y}_{m,mat}; a combiner for generating P L-dimensional sub-equivalent channel matched filtered vectors \vec{y}ₘₐₜⁱ (i=1, . . . ,P) using the sub-channel matched filtered vectors \vec{y}_{m,mat}ⁱ; and an interference cancellation decoder for performing iterative interference cancellation and maximum likelihood (ML) decoding on each of the L-dimensional sub-equivalent channel matched filtered vectors \vec{y}ₘₐₜ, and demodulating P L-dimensional sub-input vectors \vec{x}ⁱ (i=1, . . . ,P).

Each of the plurality of grouping units includes a first extraction module for extracting signals from each of the channel matched filtered vectors \vec{y}_{m,mat} output by the channel matched filters in a unit of L signals such that the signals do not overlap with each other; and a plurality of grouping modules for grouping the L signals extracted from the first extraction module and generating the P L-dimensional sub-channel matched filtered vectors \vec{y}_{m,mat}ⁱ.

The combiner includes a plurality of second extraction modules for extracting vectors from the P sub-channel matched filtered vectors \vec{y}_{m,mat}ⁱ outputted by each of the plurality of grouping units one by one; and a plurality of combination modules for combining M vectors extracted from the plurality of second extraction modules and generating the P L-dimensional sub-equivalent channel matched filtered vectors \vec{y}ₘₐₜⁱ.

The interference cancellation decoder includes an interference canceller for performing iterative interference cancellation on each of the sub-equivalent channel matched filtered vectors \vec{y}ₘₐₜⁱ I times and generating K_{I} different estimation candidate vectors \vec{x}ₖ_{_{I}}^{i,(I)} (i=1, . . . ,P) for the L-dimensional sub-input vectors \vec{x}ⁱ; and an ML decoder for performing ML decoding on the estimation candidate vectors \vec{x}ₖ_{_{I}}^{i,(I)} and demodulating the P L-dimensional sub-input vectors \vec{x}ⁱ.

The decoding apparatus performs channel matched filtering on M N-dimensional equivalent reception vectors \vec{y}ₘ (m=1, . . . ,M) received through M receive antennas and outputting N-dimensional channel matched filtered vectors \vec{y}_{m,mat} (m=1, . . . ,M); generates P L-dimensional sub-channel matched filtered vectors \vec{y}_{m,mat}ⁱ (i=1, . . . ,P, m=1, . . . ,M) from each of the N-dimensional channel matched filtered vectors \vec{y}_{m,mat}; generates P L-dimensional sub-equivalent channel matched filtered vectors \vec{y}ₘₐₜⁱ (i=1, . . . ,P) using the sub-channel matched filtered vectors \vec{y}_{m,mat}ⁱ; and performs iterative interference cancellation and maximum likelihood (ML) decoding on each of the L-dimensional sub-equivalent channel matched filtered vectors \vec{y}ₘₐₜⁱ, and demodulating P L-dimensional sub-input vectors \vec{x}ⁱ (i=1, . . . ,P).

The sub-input vectors xi are demodulated from the sub-equivalent channel matched filtered vectors \vec{y}ₘₐₜⁱ, respectively.

(L−1)-dimensional symbol vectors, from which a symbol xᵢ_{_{I}} associated with one arbitrary element y_{mat,I}ⁱ within the sub-equivalent channel matched filtered vectors \vec{y}ₘₐₜⁱ is excluded, are defined as interference symbol vectors. The interference canceller eliminates interference from a plurality of initial interference symbol candidate vectors in one arbitrary element y_{mat,I}ⁱ within the sub-equivalent channel matched filtered vectors \vec{y}ₘₐₜⁱ, and generates a plurality of signals from which the interference has been eliminated.

The interference canceller selects an arbitrary number of vectors, serving as candidate vectors of initial interference symbol vectors before performing the interference cancellation, from all (L−1)-dimensional symbol vectors from which a symbol xᵢ_{_{I}}, associated with one arbitrary element y_{mat,I}ⁱ within the sub-equivalent channel matched filtered vectors \vec{y}ₘₐₜⁱ, is excluded. For example, a method for determining the initial interference symbol vectors can select all Q^{L-1} vectors.

Alternatively, the interference canceller may select K₁ (K₁≦Q^{L-1}) arbitrary candidates of all Q^{L-1} candidates for the (L−1)-dimensional symbol vectors closest to the sub-equivalent channel matched filtered vectors \vec{y}ₘₐₜⁱ from the candidate vectors of the initial interference symbol vectors. However, the interference canceller may select only candidates present in a predetermined distance from the sub-equivalent channel matched filtered vectors \vec{y}ₘₐₜⁱ at

The interference canceller determines symbols xᵢ_{_{I}} from the signals from which interference has been eliminated to generate the estimation candidate vectors, and combines values of the determined symbols xᵢ_{_{I}} and the (L−1)-dimensional interference symbol vectors associated therewith.

The interference canceller performs iterative interference cancellation to reduce the number of estimation candidate vectors to be generated after eliminating interference from the sub-equivalent channel matched filtered vectors \vec{y}ₘₐₜⁱ.

The estimation candidate vectors \vec{x}ₖ_{_{I}}^{i,(I)} are generated after iterative interference cancellation are performed on the sub-equivalent channel matched filtered vectors \vec{y}ₘₐₜⁱ I times.

The interference canceller selects new estimation candidate vectors by selecting only vectors that are different from the estimation candidate vectors generated after performing the interference cancellation in a method for determining the estimation candidate vectors after performing the interference cancellation.

The interference canceller performs iterative interference cancellation on the sub-equivalent channel matched filtered vectors \vec{y}ₘₐₜⁱ I times and determines K_{I} different estimation candidate vectors \vec{x}ₖ_{_{I}}^{i,(I)}. As the iterative interference cancellation is performed, the number of different estimation candidate vectors is gradually reduced.

The ML decoder performs the ML decoding on the K_{I} estimation candidate vectors \vec{x}ₖ_{_{I}}^{i,(I)} generated from the interference canceller, and demodulates the L-dimensional sub-input vectors \vec{x}ⁱ.

When all Q^{L-1} symbol vectors are selected as candidates of initial interference symbol vectors in one example of an estimation candidate vector generating method, Q^{L-1} different estimation candidate vectors \vec{x}ₖ_{_{I}}^{i,(I)} are generated through one interference cancellation operation.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a decoding apparatus in accordance with a preferred embodiment of the present invention;

FIG. 2 is a block diagram illustrating details of a grouping unit of FIG. 1;

FIG. 3 is a block diagram illustrating details of a combiner of FIG. 1; and

FIG. 4 is a block diagram illustrating details of an interference cancellation decoder of FIG. 1.

### DETAILED DESCRIPTION OF THE PREFERRED EMBODIMENTS

Preferred embodiments of the present invention will be described with reference to the accompanying drawings.

In a method for decoding quasi-orthogonal space-time block codes (STBCs) in accordance with the present invention, it is assumed that a wireless communication system includes N transmit antennas and M receive antennas, where M≧1 and N≧2.

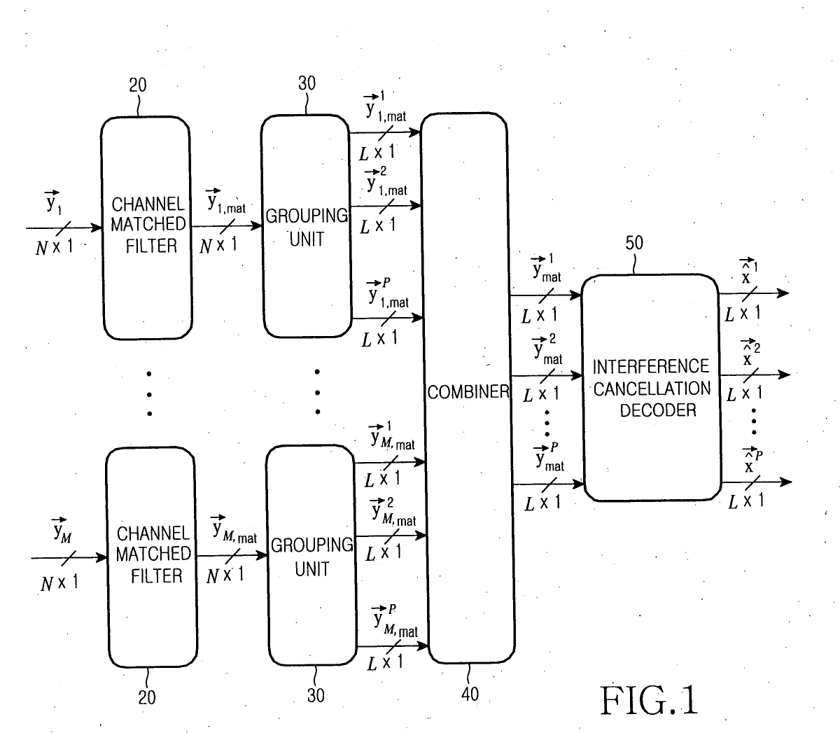

FIG. 1 is a block diagram illustrating a decoding apparatus in accordance with a preferred embodiment of the present invention.

As illustrated in FIG. 1, the decoding apparatus includes a plurality of channel matched filters 20, a plurality of grouping units 30, a combiner 40, and an interference cancellation decoder 50. The channel matched filters 20 perform channel matched filtering on equivalent reception vectors \vec{y}ₘ (m=1, . . . ,M) and output N-dimensional channel matched filtered vectors \vec{y}_{m,mat} (m=1, . . . ,M The grouping units 30 generate P L-dimensional sub-channel matched filtered vectors \vec{y}_{m,mat}ⁱ (i=1, . . . ,P, m=1, . . . ,M) from the channel matched filtered vectors \vec{y}_{m,mat}, respectively. The combiner 40 generates P L-dimensional sub-equivalent channel matched filtered vectors \vec{y}ₘₐₜⁱ (i=1, . . . ,P) using the sub-channel matched filtered vectors \vec{y}_{m,mat}. The interference cancellation decoder 50 performs iterative interference cancellation and maximum likelihood (ML) decoding on each of the sub-equivalent channel matched filtered vectors \vec{y}ₘₐₜⁱ and demodulates P L-dimensional sub-input vectors \vec{x}ⁱ (i=1, . . . ,P).

In quasi-orthogonal space-time block codes (STBCs), all elements of an N×N codeword matrix G(\vec{x}) are complex linear combinations of N quadrature amplitude modulation (QAM) symbols x₁,x₂, . . . ,x_{N} within an input vector \vec{x} and their complex conjugate values x₁*,x₂*, . . . ,x_{N}*. The codeword matrix G(\vec{x}) can be expressed as shown in Equation (1).

$$G ( \vec{x} ) = {\sum }_{i = 1}^{N} {G}_{i} ( {x}_{i} ) \qquad ( 1 )$$

In Equation (1), Gᵢ(xᵢ) denotes an N×N modulation matrix for symbols xᵢ, where elements of Gᵢ(xᵢ) are complex linear combinations of the symbols xᵢ and their complex conjugate values.

The codeword matrix G(\vec{x}) can be decomposed as shown in Equation (2).

$$G ( \vec{x} ) = {\sum }_{i = 1}^{P} {A}_{i} ( {\vec{x}}^{i} ) \qquad ( 2 )$$

In Equation (2), a matrix Aᵢ(\vec{x}ⁱ) is a sum of modulation matrices Gᵢ_{_{I}}(xᵢ_{_{I}}), . . . , Gᵢ_{_{L}}(xᵢ_{_{L}}) associated with input symbols xᵢ_{₁}, xᵢ_{₂}, . . . , xᵢ_{_{L}}, (iₗ∈={1,2, . . . ,N}, l=1,2, . . . ,L) belonging to the i-th group when x₁,x₂, . . . , x_{N} are grouped into P (P=N/L) groups in a unit of L symbols such that they do not overlap with each other, and \vec{x}ⁱ=[xᵢ_{_{I}}, . . . , xᵢ_{_{L}}]^{T}. That is,

$${A}_{i} ( {\vec{x}}^{i} ) = {\sum }_{l = 1}^{L} {G}_{{i}_{l}} ( {x}_{{i}_{l}} ) .$$

In the quasi-orthogonal STBCs, the matrix Aᵢ(\vec{x}ⁱ) can be selected such that Equation (3) is satisfied.

$${\sum }_{i < j} ( {{A}_{i} ( {\vec{x}}^{i} )}^{H} {A}_{j} ( {\vec{x}}^{j} ) + {{A}_{j} ( {\vec{x}}^{j} )}^{H} {A}_{i} ( {\vec{x}}^{i} ) ) = {0}_{N \times N} \qquad ( 3 )$$

The condition of Equation (3) indicates that ML decoding can be performed on symbols belonging to one group independent of symbols belonging to another group when xᵢ_{₁}, xᵢ_{₂}, . . . , xᵢ_{_{L}} (iₗ∈{1,2, . . . ,N}, l=1,2, . . . ,L) symbols associated with the matrix Aᵢ(\vec{x}ⁱ) are grouped into the one group.

In a transmitter for encoding data into quasi-orthogonal STBCs and transmitting the quasi-orthogonal STBCs, one codeword matrix G(\vec{x}) is generated when one arbitrary N-dimensional input vector \vec{x} is input, and columns of the codeword matrix G(\vec{x}) are transmitted through different transmit antennas.

It is assumed that a channel between each transmit antenna and each receive antenna is an independent Rayleigh fading channel. Moreover, it is assumed that the channel is a quasi-static channel in which a channel value is not varied while one codeword matrix is transmitted. When a complex low-pass equivalent reception signal received from the m-th receive antenna during the t-th time interval is denoted by r_{l,m}, a reception vector \vec{r}ₘ received during N symbol periods is given as shown in Equation (4).

$${\vec{r}}_{m} = {[ {r}_{1 , m} , … , {r}_{N , m} ]}^{T} = \frac{1}{\sqrt{N}} G {\vec{h}}_{m} + {\vec{n}}_{m} \qquad ( 4 )$$

In Equation (4), a channel vector \vec{h}ₘ=[h_{l,m}, . . . ,h_{N,m}]^{T} and the (n,m)-th channel value h_{n,m}=h_{n,m}^{I}+jh_{n,m}^{Q} is an independent and identical distributed (i.i.d.) complex channel gain between the n-th transmit antenna and the m-th receive antenna, where h_{n,m}^{I} and h_{n,m}^{Q} are i.i.d. Gaussian random variables with a mean value of 0 and a variance value of 0.5. Further, \vec{n}ₘ=[n_{n,m}, . . . ,n_{N,m}]^{T} and n_{t,m}=n_{t,m}^{I}+jn_{t,m}^{Q} denote the contribution of background thermal noise modeled by i.i.d. random variables in r_{t,m}, where n_{t,m}^{I} and n_{t,m}^{Q} are Gaussian random variables with a mean value of 0 and a variance value of N₀/2. A codeword matrix is normalized to

$$\frac{1}{\sqrt{N}}$$

such that total transmission power is equal to that of a non-coding system, not using STBCs.

When complex conjugates are taken for rows of the reception vector \vec{r}ₘ associated with indices of rows configured only by complex linear combinations of x₁*,x₂*, . . . ,x_{N}* in the codeword matrix G(\vec{x}), an equivalent reception vector \vec{y}ₘ is generated. The equivalent reception vector \vec{y}ₘ can be expressed as shown in Equation (5) based on an input vector \vec{x}.
\vec{y}=Hₘ\vec{x}+\vec{n}′ₘ (5)

In Equation (5), elements of a channel matrix Hₘ are complex linear combinations of

$$\frac{{h}_{1 , m}}{\sqrt{N}} , … , \frac{{h}_{N , m}}{\sqrt{N}} , \frac{{h}_{1 , m}^{*}}{\sqrt{N}} , … , \frac{{h}_{N , m}^{*}}{\sqrt{N}} .$$

Here, \vec{n}′ₘ=[n′_{m,1}, . . . ,n′_{m,N}]^{T} denotes a noise vector obtained by taking complex conjugates of rows of \vec{n}ₘ associated with indices of rows in which complex conjugates are taken for the reception vector \vec{r}ₘ in order to generate the equivalent reception vector \vec{y}ₘ. The statistical characteristics of \vec{n}′ₘ are the same as those of \vec{n}ₘ.

Under an assumption that the channel matrix Hₘ is known, the receiving stage can perform ML decoding and select an N-dimensional input vector \hat{\vec{x}} as shown in Equation (6).

$$\begin{matrix}{x}^{\vec{⋀}} = arg {min}_{\vec{x}} {\sum }_{m = 1}^{M} {‖ {\vec{y}}_{m} - \frac{1}{\sqrt{N}} G ( \vec{x} ) {\vec{h}}_{m} ‖}^{2} \\ = arg {min}_{\vec{x}} {\sum }_{m = 1}^{M} [ - \frac{1}{\sqrt{N}} {\sum }_{i = 1}^{N} ( {\vec{y}}_{m}^{H} {G}_{i} ( {x}_{i} ) {\vec{h}}_{m} + \\ {\vec{h}}_{ m}^{ H} { {G}_{ i} ( {x}_{ i} )}^{H} { \vec{y}}_{ m} ) + \frac{1}{N} {\vec{h}}_{m}^{H} ( {\sum }_{i = 1}^{P} {{A}_{i} ( {\vec{x}}^{i} )}^{H} ) ( {\sum }_{i = 1}^{P} {A}_{i} ( {\vec{x}}^{i} ) ) {\vec{h}}_{m} ] \\ = arg {min}_{\vec{x}} {\sum }_{m = 1}^{M} [ - \frac{1}{\sqrt{N}} {\sum }_{i = 1}^{N} ( {\vec{y} }_{m}^{H} {G}_{i} ( {x}_{i} ) {\vec{h} }_{m} + \\ {\vec{h} }_{m}^{ H} { {G}_{ i} ( {x}_{ i} )}^{H} { \vec{y} }_{m} ) + \frac{1}{N} {\vec{h}}_{m}^{H} ( {\sum }_{i = 1}^{P} {{A}_{i} ( {\vec{x}}^{i} )}^{H} {A}_{i} ( {\vec{x}}^{i} ) ) {\vec{h} }_{m} ]\end{matrix} \qquad ( 6 )$$

In Equation (6), ∥ ∥ denotes a Frobenius norm value. Equation (6) is divided into P Equations. As shown in Equation (7), of the P Equations, an L-dimensional subvector \hat{\vec{x}}ⁱ can be selected.

$${{x}^{\vec{⋀}}}^{i} = arg {min}_{{}^{ {\vec{x}}^{i}}} {\sum }_{m = 1}^{M} [ \frac{1}{N} {\vec{h} }_{m}^{ H} {{A}_{i} ( {\vec{x}}^{i} )}^{H} {A}_{i} ( {\vec{x}}^{i} ) {\vec{h} }_{m} - \frac{1}{\sqrt{N}} {\sum }_{j = 1}^{L} ( {\vec{y} }_{m}^{H} {G}_{{i}_{j}} ( {x}_{i} ) {\vec{h} }_{m} + {\vec{h} }_{m}^{ H} { {G}_{ {i}_{j}} ( {x}_{ i} )}^{H} { \vec{y} }_{m} ) ] \qquad ( 7 )$$

When the ML decoding method is used, the ML decoding can be performed on each of the P L-dimensional sub-input vectors \vec{x}ⁱ.

The channel matched filter 20 multiplies the equivalent reception vector \vec{y}ₘ by the complex conjugate transpose matrix Hₘ^{H} of the channel matrix Hₘ, and generates a channel matched filtered vector \vec{y}m,mat as shown in Equation (8).
\vec{y}_{m,mat}=Hₘ^{H}\vec{y}ₘ=(Hₘ^{H}Hₘ)\vec{x}+Hₘ^{H}\vec{n}′ₘ (8)

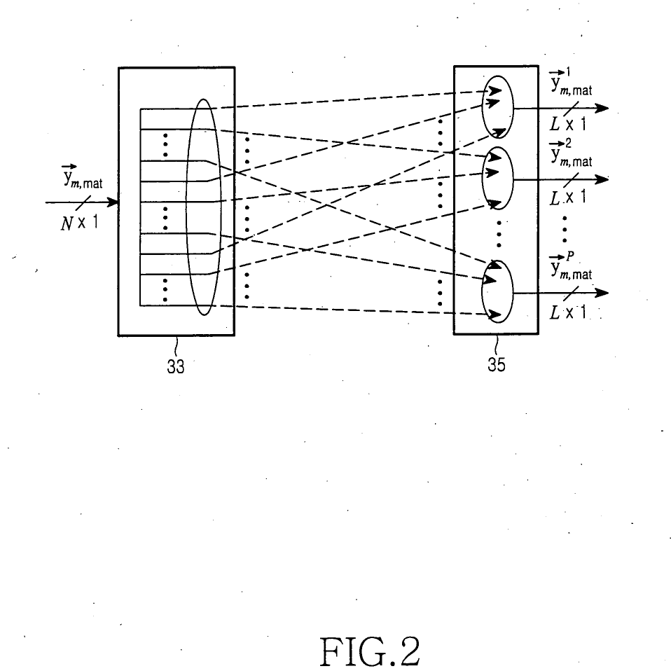

FIG. 2 illustrates details of the grouping unit 30 of FIG. 1. The grouping unit 30 includes a first extraction module 33 for extracting signals from each of the channel matched filtered vectors \vec{y}_{m,mat} output by the channel matched filters in a unit of L signals such that the signals do not overlap with each other, and a plurality of grouping modules 35 for grouping the L signals extracted from the first extraction module 33 and generating the P L-dimensional sub-channel matched filtered vectors \vec{y}_{m,mat}ⁱ. The grouping unit 30 groups elements y_{m,mat,i}_{_{I}}, . . . ,y_{m,mat}_{_{L}} of a channel matched filtered vector \vec{y}_{m,mat} associated with indices i_{I}, . . . ,i_{L} of symbols within an L-dimensional sub-input vector \vec{x}ⁱ, and generates L-dimensional sub-channel matched filtered vectors \vec{y}_{m,mat}.

The channel matrix Hₘ can be written as shown in Equation (9).
Hₘ[\vec{H}_{m,I}, . . . ,\vec{H}_{m,N}] (9)

Here, \vec{H}_{m,n} denotes the n-th N-dimensional column vector of the channel matrix Hₘ.

When column vectors associated with indices i₁, . . . ,i_{L} in the channel matrix Hₘ are grouped, an N×L sub-channel matrix Hₘⁱ as shown in Equation (10) can be generated.
Hₘⁱ=[\vec{H}_{m,i}_{_{I}}, . . . ,\vec{H}_{m,i}_{_{L}}] (10)

When elements associated with indices i₁, . . . ,i_{L} in the noise vector \vec{n}′ₘ are grouped, a sub-noise vector is defined as (\vec{n}′ₘ)ⁱ=[n′_{m,i}_{_{I}}, . . . ,n′_{m,i}_{_{L}}]^{T}.

The sub-channel matched filtered vectors \vec{y}_{m,mat}ⁱ generated by the grouping unit 30 can be expressed as shown in Equation (11) due to quasi-orthogonal characteristics of the quasi-orthogonal STBCs.
\vec{y}_{m,mat}ⁱ=Rₘⁱ\vec{x}ⁱ′\vec{v}ₘⁱ (11)

In Equation (11), Rₘⁱ=(Hₘⁱ)^{H} Hₘⁱ denotes an L×L sub correlation matrix, and \vec{v}ₘⁱ=(Hₘⁱ)^{H}(\vec{n}′ₘ)ⁱ denotes a channel matched filtered sub-noise vector.

An arbitrary element y_{m,mat}ⁱ within the sub-channel matched filtered vector \vec{y}_{m,mat}ⁱ includes only components xᵢ_{₁},xᵢ_{₂}, . . . , xᵢ_{_{L}} of the input symbols, and (L−1) symbols xᵢ_{₁}, . . . , xᵢ_{ᵢ₋₁}, xᵢ_{ᵢ₊₁}, . . . , xᵢ_{_{L}} except a symbol xᵢ_{_{I}} serves as an interference to xᵢ^{I}.

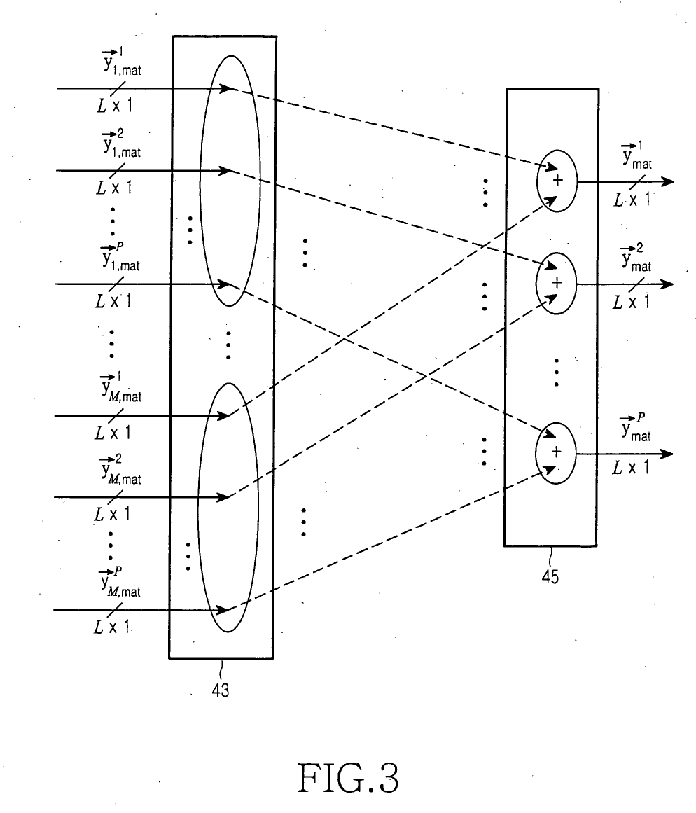

FIG. 3 is a block diagram illustrating details of the combiner 40. The combiner 40 includes a plurality of second extraction modules 43 for extracting vectors from the P sub-channel matched filtered vectors \vec{y}_{m,mat}ⁱ output by each of the plurality of grouping units one by one. The combiner 40 also includes a plurality of combination modules 45 for combining M vectors extracted from the plurality of second extraction modules 43 and generating the P L-dimensional sub-equivalent channel matched filtered vectors \vec{y}ₘₐₜⁱ. The combiner 40 adds sub-channel matched filtered vectors \vec{y}_{m,mat}ⁱ corresponding to the i-th output vectors of the grouping units and outputs sub-equivalent channel matched filtered vectors \vec{y}ₘₐₜⁱ as shown in Equation (12).

$${\vec{y} }_{mat}^{i} = {\sum }_{m = 1}^{M} {\vec{y} }_{m , mat}^{i} = R {x}^{i \to i} + {\vec{v}}^{i} \qquad ( 12 )$$

In Equation (12),

$${R}^{i} = ( {\sum }_{m = 1}^{M} {R}_{m}^{i} )$$

is an L×L sub-equivalent correlation matrix, and

$${{v}^{->}}^{i} = {\sum }_{m = 1}^{M} {{v}^{->}}_{m}^{i}$$

is an L -dimensional sub-equivalent noise vector.

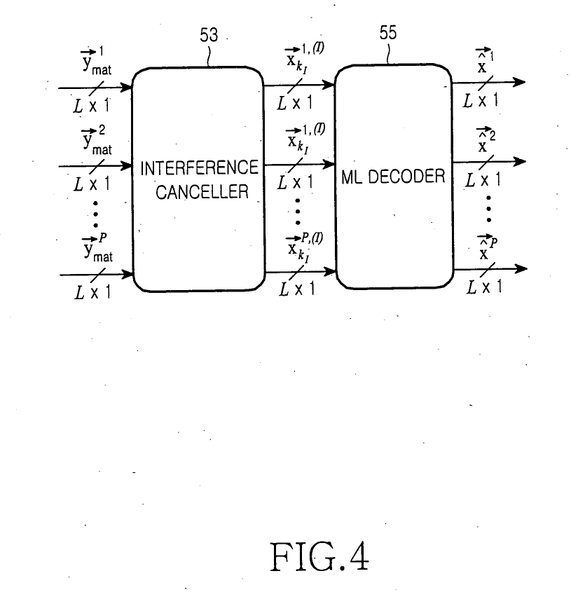

FIG. 4 is a block diagram illustrating details of the interference cancellation decoder 50. The interference cancellation decoder performs iterative interference cancellation on sub-channel matched filtered vectors \vec{y}ₘₐₜⁱ I times and generates estimation vectors \vec{x}ₖ_{_{I}}^{i,(I)} for sub-input vectors \vec{x}ⁱ. The interference cancellation decoder performs ML decoding on the estimation vectors and demodulates the sub-input vectors \vec{x}ⁱ.

For a given modulation order Q, a set of Q constellation symbols is defined as S={s₁,s₂, . . . ,s_{Q}}. A set of (L−1)-dimensional constellation symbol vectors is defined as W={[w₁, . . . W_{L-1}]^{T}|wᵢ∈S}. The number of candidates for an arbitrary symbol xᵢ_{_{I}}∈S is Q. The number of possible candidates for a (L−1)-dimensional symbol vector \vec{z}ᵢ_{_{I}}=[xᵢ_{_{I}}, . . . ,xᵢ_{ᵢ₋₁}, xᵢ_{ᵢ₊₁}, . . . ,xᵢ_{_{L}}∈W except for xᵢ_{_{I}} is Q^{L-1}.

The (L−1)-dimensional symbol vector \vec{z}_{I}ⁱ except the symbol xᵢ_{_{I}} associated with one arbitrary element y_{mat,I}ⁱ within the sub-equivalent channel matched filtered vector \vec{y}ₘₐₜⁱ serves as an interference symbol vector to the symbol xᵢ_{_{I}}, and arbitrary vectors serving as candidates of an initial interference symbol vector can be selected from the set W.

For example, all Q^{L-1} vectors belonging to the set W can be selected as candidates of an interference symbol vector \vec{z}_{I}ⁱ=[xᵢ_{₂}, . . . ,xᵢ_{_{L}}]^{T}, except the symbol xᵢ_{_{I}} associated with y_{mat,I}ⁱ. Alternatively, K_{I}(≦Q^{L-1}) candidates closest to the sub-equivalent channel matched filtered vector \vec{y}ₘₐₜⁱ can be selected from all the Q^{L-1} candidates, and only candidates present within a predetermined distance from the sub-equivalent channel matched filtered vector \vec{y}ₘₐₜⁱ can be selected.

Because the symbols xᵢ_{₂}, . . . , xᵢ_{_{L}} in the element y_{mat,I}ⁱ serve as interference to the symbol xᵢ_{_{I}}, an interference component associated with each candidate of the interference symbol vector \vec{z}_{I}ⁱ in the element y_{mat,I}ⁱ is eliminated as shown in Equation (13), such that y_{mat,I,k}_{I}^{i,(I)} is generated.

$${y}_{mat , 1 , {k}_{1}}^{i , ( 1 )} = {y}_{mat , 1}^{i} - {\sum }_{j \neq 1}^{L} {( {R}^{i} )}_{1 , j} {z}_{1 , {k}_{1} , j}^{i , ( 1 )} \qquad ( 13 )$$

The superscript b of z_{l,k}_{_{b}}_{,j}^{i(b)} denotes an index in the current interference cancellation step, and z_{l,k}_{_{b}}_{,j}^{i,(b)} denotes the j-th element of \vec{z}_{l,k}_{_{b}}^{i,(b)} serving as the k_{b}-th candidate of the interference symbol vector \vec{z}ₗⁱ in the b-th interference cancellation step. (Rⁱ)_{l,j} denotes the (l,j)-th element of the sub-equivalent correlation matrix Rⁱ, and y_{mat,l,k}_{_{b}}^{i,(b)} denotes a value of a signal from which an interference component has been eliminated, associated with the k_{b}-th interference symbol vector candidate in the l-th element y_{mat,l}ⁱ of the sub-channel matched filtered vector \vec{y}ₘₐₜⁱ. The number of candidates of the (L−1)-dimensional interference symbol vector \vec{z}ₗⁱ is defined as K_{b}. Accordingly, kₗ denotes indices of candidates of the interference symbol vector \vec{z}ₗⁱ serving as interference to xᵢ_{₁} in the first interference cancellation step. When all the vectors belonging to the set W are selected as candidates of \vec{z}₁ⁱ, the number of candidates of \vec{z}₁ⁱ is Q^{L-1}.

In the first interference cancellation step, the k₁-th interference symbol vector candidate \vec{z}_{1,k}_{_{I}}^{i,(I)} determines the symbol xᵢ_{₁} from a signal y_{mat,l,k}_{I}^{i,(I)} from which interference has been eliminated. In this case, a determined value is referred to as xᵢ_{_{I}}_{,k}_{_{I}}^{(I)}. Then, K₁ candidate symbols associated with the symbol xᵢ_{₁} are generated in the first interference cancellation step, and K₁ estimation vectors \vec{x}ₖ_{_{I}}^{i,(I)} for the sub-input vectors \vec{x}ⁱ can be obtained as shown in Equation (14).
\vec{x}ₖ_{₁}^{i,(I)}=[xᵢ_{₁}_{,k}_{₁}⁽¹⁾,xᵢ_{₂}_{,k}_{₁}⁽⁰⁾,xᵢ_{₃}_{,k}_{₁}⁽⁰⁾, . . . ,xᵢ_{_{L}}_{,k}_{₁}⁽⁰⁾]^{T} (14)

In Equation (14), a number included in the superscript ( ) denotes an interference cancellation step index. Here, xᵢ_{₂}_{,k}_{₁}⁽⁰⁾, . . . ,xᵢ_{_{L}}_{,k}_{₁}⁽⁰⁾ denote symbols with a vector associated with the k₁-th candidate of the interference symbol vector \vec{z}₁ⁱ before the initial interference cancellation step.

An (L−1)-dimensional interference symbol vector \vec{z}₂ⁱ in which the i₂-th symbol is excluded from the K_{I} estimation vectors \vec{x}ₖ_{_{I}}^{i,(1)} has K_{I} candidates \vec{z}_{2,k}_{_{I}}^{i,(2)}=[xᵢ_{₁}_{,k}_{₁}⁽¹⁾,xᵢ_{₃}_{,k}_{₁}⁽⁰⁾,xᵢ_{₄}_{,k}_{₁}⁽⁰⁾, . . . ,xᵢ_{_{L}}_{,k}_{₁}⁽⁰⁾]^{T}. Because (L−1)-dimensional interference symbol vector candidates are vectors generated by removing one element from L-dimensional estimation vector candidates, the same interference symbol vector candidates for different estimation vector candidates may be generated. In this case, only different interference symbol vector candidates are selected. One method for selecting different candidates selects an index k₂ in which Equation (15) is satisfied from the K₁ interference symbol vector candidates. Candidates of \vec{z}₂ⁱ associated with the selected index k₂ are denoted by \vec{z}_{2,k}_{₂}^{i,(2)}, and the number of different candidates is defined as K₂ (K₂≦K₁).
k₂∈{1,w|\vec{z}_{2,w}^{i,(2)}≠\vec{z}_{2,u}^{i,(2)},^{∀}u,1≦u≦w≦K₁} (15)

Because the symbols xᵢ_{₁},xᵢ_{₃}, . . . ,xᵢ_{_{L}} in the element y_{mat,2}ⁱ in the second interference cancellation step serve as an interference to the symbol xᵢ_{₂}, an interference component associated with each candidate of the interference symbol vector \vec{z}₂ⁱ is eliminated as shown in Equation (16), such that y_{mat,2,k}_{₂}^{i,(2)} is generated.

$${y}_{mat , 2 , {k}_{2}}^{i , ( 2 )} = {y}_{mat , 2}^{i} - {\sum }_{j \neq 2}^{L} {( {R}^{i} )}_{2 , j} {z}_{2 , {k}_{2} , j}^{i , ( 2 )} \qquad ( 16 )$$

In Equation (16), (Rⁱ)_{2,j} denotes the (2,j)-th element of the sub correlation matrix Rⁱ, and z_{2,k}_{₂}_{,j}^{i,(2)}, denotes the j-th element of the interference symbol vector \vec{z}_{2,k}_{₂}ⁱ⁽²⁾.

In the second interference cancellation step, the k₂-th interference symbol vector candidate \vec{z}_{2,k}_{₂}ⁱ⁽²⁾ determines the symbol xᵢ_{₂} from a signal y_{mat,2,k}_{₂}^{i,(2)} from which interference has been eliminated. In this case, a determined value is referred to as xᵢ_{₂}_{,k}_{₂}⁽²⁾. Then, K₂ candidate symbols associated with the symbol xᵢ_{₂} are generated in the second interference cancellation step, and K₂ estimation vectors \vec{x}ₖ_{₂}^{i,(2)}=[xᵢ_{₁}_{,k}_{₂}⁽¹⁾,xᵢ_{₂}_{,k}_{₂}⁽²⁾,xᵢ_{₃}_{,k}_{₂}⁽⁰⁾, . . . ,xᵢ_{_{L}}_{,k}_{₂}⁽⁰⁾]^{T} for the sub-input vectors \vec{x}ⁱ can be obtained.

An (L−1)-dimensional interference symbol vector \vec{z}₃ⁱ in which the i₃-th symbol is excluded from the K₂ estimation vectors \vec{x}ₖ_{₂}^{i,(2)} has K₂ candidates \vec{z}_{3,k}_{₂}^{i,(3)}=[xᵢ_{₁}_{,k}_{₂}⁽¹⁾,xᵢ_{₂}_{,k}_{₂}⁽²⁾,xᵢ_{₄}_{,k}_{₂}⁽⁰⁾, . . . xᵢ_{_{L}}_{,k}_{₂}⁽⁰⁾]^{T}. To select different interference symbol vector candidates, an index is selected using Equation (15) and the selected index is referred to as k₃. Candidates of the interference symbol vector \vec{z}₃ⁱ are \vec{z}_{3,k}_{₃}^{i,(2)}=[xᵢ_{₁}_{,k}_{₃}⁽¹⁾,xᵢ_{₂}_{,k}_{₃}⁽²⁾,xᵢ_{₄}_{,k}_{₃}⁽⁰⁾, . . . ,xᵢ_{_{L}}_{,k}_{₃}⁽⁰⁾]^{T}, and K₃ (K₃≦K₂) candidates are generated.

When the interference cancellation process is continuously performed L times, K_{L} (K_{L}≦ . . . ≦K₁) candidate symbols associated with the symbol xᵢ_{_{L}} are generated from y_{mat,L}ⁱ, and K_{L} (K_{L}≦K_{L-1}) estimation vector candidates \vec{x}ₖ_{₂}^{i,(L)}=[xᵢ_{₁}_{,k}_{₂}⁽¹⁾, . . . ,xᵢ_{_{L−1}}_{,k}_{₂}^{(L-1)},xᵢ_{_{L}}_{,k}_{_{L}}^{(L)}]^{T} for the sub-input vectors \vec{x}ⁱ can be obtained. Furthermore, K_{L+1} (K_{L+1}≦K_{L}) different candidates \vec{z}_{1,k}_{_{L}}^{i,(L+1)}=[xᵢ_{₂}_{,k}_{_{L}}⁽²⁾, . . . ,xᵢ_{_{L−1}}_{,k}_{₂}^{(L-1)},xᵢ_{_{L}}_{,k}_{_{L}}^{(L)}]^{T} can be obtained for the interference symbol vector \vec{z}₁ⁱ associated with the K_{L} estimation vector candidates \vec{x}ₖ_{_{L}}^{i,(L)}. Interference components associated with K_{L+1} different candidates \vec{x}ₖ_{_{L}}^{i,(L+1)} of the interference symbol vector \vec{z}_{I}ⁱ are removed from y_{mat,I}ⁱ and the symbol xᵢ_{_{I}} can be re-determined.

After the interference cancellation is continuously performed I times, K_{I} estimation candidate vectors \vec{x}ₖ_{_{I}}^{i,(I)} for the sub-input vectors \vec{x}ⁱ can be obtained. This case can reduce the number of estimation candidate vectors as compared with one interference cancellation operation.

As shown in FIG. 4, an ML decoder 55 performs ML decoding on K_{I} different estimation candidate vectors and demodulates L-dimensional sub-input vectors \vec{x}ⁱ. Accordingly, the inventive ML decoding method can reduce decoding complexity as compared with the conventional ML decoding method.

In accordance with the present invention, an interference canceller 53 generates K₂ different estimation vectors \vec{x}ₖ_{₂}^{i,(2)} after performing the interference cancellation twice, and selects estimation vector candidates associated with an index k₂ in which a condition of xᵢ_{₂}_{,k}_{₁}⁽⁰⁾=xᵢ_{₂}_{,k}₂⁽²⁾ is satisfied. The ML decoding is performed on the selected estimation vector candidates, such that the L-dimensional sub-input vectors \vec{x}ⁱ can be demodulated. Accordingly, decoding complexity can be reduced.

In accordance with the present invention, the decoding apparatus includes an interference canceller and an ML decoder that are connected to each other, such that a gain for reducing decoding complexity can be obtained even when arbitrary transmit antennas are used in quasi-orthogonal STBCs.

In accordance with the present invention, the decoding method uses an iterative interference cancellation and ML decoding scheme, such that it can reduce decoding complexity without sudden performance loss as compared with the ML decoding method.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An apparatus for receiving and decoding quasi-orthogonal space-time block codes (STBCs) from a transmitter for encoding data into the quasi-orthogonal STBCs and transmitting the STBCs using a plurality of transmit antennas, comprising:
a plurality of channel matched filters for performing channel matched filtering on M N-dimensional equivalent reception vectors \vec{y}ₘ (m=1, . . . ,M) received through M receive antennas and outputting N-dimensional channel matched filtered vectors \vec{y}_{m,mat} (m=1, . . . ,M);
a plurality of grouping units for generating P L-dimensional sub-channel matched filtered vectors \vec{y}_{m,mat}ⁱ (i=1, . . . ,P, m=1, . . . ,M) from each of the N-dimensional channel matched filtered vectors \vec{y}_{m,mat};
a combiner for generating P L-dimensional sub-equivalent channel matched filtered vectors \vec{y}ₘₐₜⁱ (i=1, . . . ,P) using the sub-channel matched filtered vectors \vec{y}_{m,mat}ⁱ; and
an interference cancellation decoder for performing iterative interference cancellation and maximum likelihood (ML) decoding on each of the L-dimensional sub-equivalent channel matched filtered vectors \vec{y}ₘₐₜⁱ, and demodulating P L-dimensional sub-input vectors \vec{x}ⁱ (i=1, . . . ,P).

2. The apparatus of claim 1, wherein each of the plurality of grouping units comprises:
a first extraction module for extracting signals from each of the channel matched filtered vectors \vec{y}_{m,mat} output by the channel matched filters in a unit of L signals such that the signals do not overlap with each other; and
a plurality of grouping modules for grouping the L signals extracted from the first extraction module and generating the P L-dimensional sub-channel matched filtered vectors \vec{y}_{m,mat}ⁱ.

3. The apparatus of claim 1, wherein the combiner comprises:
a plurality of second extraction modules for extracting vectors from the P sub-channel matched filtered vectors \vec{y}_{m,mat}ⁱ output by each of the plurality of grouping units one by one; and
a plurality of combination modules for combining M vectors extracted from the plurality of second extraction modules and generating the P L-dimensional sub-equivalent channel matched filtered vectors \vec{y}ₘₐₜⁱ.

4. The apparatus of claim 1, wherein the interference cancellation decoder comprises:
an interference canceller for performing iterative interference cancellation on each of the sub-equivalent channel matched filtered vectors \vec{y}ₘₐₜⁱ I times and generating K_{I} different estimation candidate vectors \vec{x}ₖ_{_{I}}^{i(I)}(i=1, . . . ,P) for the L-dimensional sub-input vectors \vec{x}ᵢ; and
an ML decoder for performing ML decoding on the estimation candidate vectors \vec{x}ₖ_{_{I}}^{i(I)} and demodulating the P L-dimensional sub-input vectors \vec{x}ⁱ.

5. The apparatus of claim 1, wherein the sub-input vectors \vec{x}ⁱ are demodulated from the sub-equivalent channel matched filtered vectors \vec{y}ₘₐₜⁱ, respectively.

6. The apparatus of claim 4, wherein the interference canceller eliminates interference from a plurality of candidate vectors of an interference symbol vector configured by (L−1) symbols from which a symbol xᵢ_{_{I}} associated with one arbitrary element y_{m,mat,I}ⁱ within the sub-equivalent channel matched filtered vectors \vec{y}ₘₐₜⁱ is excluded, and generates a plurality of subvectors from which the interference has been eliminated.

7. The apparatus of claim 6, wherein the interference canceller selects an arbitrary number of vectors, serving as candidate vectors of initial interference symbol vectors before performing interference cancellation, from all (L−1)-dimensional symbol vectors from which a symbol xᵢ_{_{I}} associated with one arbitrary element y_{mat,I}ⁱ within the sub-equivalent channel matched filtered vectors \vec{y}ₘₐₜⁱ is excluded.

8. The apparatus of claim 7, wherein the interference canceller selects K₁ (K₁≦Q^{L-1}) arbitrary candidates of all Q^{L-1} candidates for the (L−1)-dimensional symbol vectors closest to the sub-equivalent channel matched filtered vectors \vec{y}ₘₐₜⁱ from the candidate vectors of the initial interference symbol vectors.

9. The apparatus of claim 7, wherein the interference canceller selects K₁ (K₁≦Q^{L-1}) candidates of the candidate vectors of the initial interference symbol vectors present in a predetermined distance from the sub-equivalent channel matched filtered vectors \vec{y}ₘₐₜⁱ.

10. The apparatus of claim 4, wherein the interference canceller determines symbols xᵢ_{_{I}} from the sub-equivalent channel matched filtered vectors \vec{y}ₘₐₜⁱ from which interference has been eliminated to generate the estimation candidate vectors \vec{x}ₖ_{_{I}}^{i,(I)}, and combines values of the determined symbols xᵢ_{_{I}} and (L−1)-dimensional interference symbol vectors associated therewith.

11. The apparatus of claim 4, wherein the interference canceller performs iterative interference cancellation to reduce the number of estimation candidate vectors to be generated after eliminating interference from the sub-equivalent channel matched filtered vectors \vec{y}ₘₐₜⁱ.

12. The apparatus of claim 4, wherein the interference canceller generates the K_{I} different estimation candidate vectors \vec{x}ₖ_{_{I}}^{i,(I)} that satisfy a condition of K₁≦K_{I-1}≦ . . . ≦K_{I} after performing iterative interference cancellation on the sub-equivalent channel matched filtered vectors \vec{y}ₘₐₜⁱ I times.

13. The apparatus of claim 12, wherein the interference canceller selects new estimation candidate vectors by selecting only vectors that are different from the estimation candidate vectors \vec{x}ₖ_{_{I}}^{i,(I)} generated after performing the interference cancellation in a method for determining the estimation candidate vectors \vec{x}ₖ_{_{I}}^{i,(I) m}after performing the interference cancellation.

14. The apparatus of claim 12, wherein the interference canceller performs the iterative interference cancellation, such that the number of different estimation candidate vectors \vec{x}ₖ_{_{I}}^{i,(I)} is gradually reduced.

15. The apparatus of claim 4, wherein the interference canceller generates K₂ different estimation candidate vectors \vec{x}ₖ_{₂}^{i,(2)} after performing two interference cancellation steps, and selects estimation vectors associated with an index k₂ in which a condition of xᵢ_{₂}_{,k}_{₁}⁽⁰⁾=xᵢ_{₂}_{,k}_{₂}⁽²⁾ is satisfied from the K₂ different estimation candidate vectors \vec{x}ₖ_{₂}^{i,(2)}.

16. The apparatus of claim 15, wherein the ML decoder performs ML decoding on the estimation vectors associated with the index k₂ in which the condition of xᵢ_{₂}_{,k}_{₁}⁽⁰⁾=xᵢ_{₂}_{,k}_{₂}⁽²⁾ m is satisfied, and demodulates the L-dimensional sub-input vectors \vec{x}ⁱ.

17. The apparatus of claim 4, wherein the ML decoder performs the ML decoding on the K_{I} estimation candidate vectors \vec{x}ₖ_{_{I}}^{i,(I)} generated from the interference canceller, and demodulates the L-dimensional sub-input vectors \vec{x}ⁱ.
